(19) United States
(12) Patent Application Publication
(10) Pub. No.: US 2016/0196615 A1
(43) Pub. Date: Jul. 7, 2016

(54) CROSS-CHANNEL FRAUD DETECTION

(71) Applicant: Wells Fargo Bank, N.A., Charlotte, NC (US)

(72) Inventors: John Yen, San Ramon, CA (US); Jeremy Norvell, Livermore, CA (US); Michelle H. Wang, Palo Alto, CA (US)

(73) Assignee: WELLS FARGO BANK, N.A., Charlotte, NC (US)

(21) Appl. No.: 14/590,382

(22) Filed: Jan. 6, 2015

(51) Int. Cl. G06Q 40/00; H04W 12/02; H04W 12/12

(52) U.S. Cl. CPC G06Q 40/12; H04W 12/12; H04W 12/02

(57) ABSTRACT

Systems and methods that facilitate detection of cross-channel fraud are discussed. Detection of cross-channel fraud includes analyzing one or more fraud accounts previously subject to fraud. The analyzing includes identifying one or more common patterns of events associated with fraud. Detection of cross-channel fraud also includes determining a cross-channel fraud metric that measures a likelihood of fraud and monitoring a plurality of events associated with a customer. The detection of cross-channel fraud also includes determining a first account fraud probability associated with the customer based at least in part on a comparison between the plurality of events and the one or more common patterns of events. The plurality of events are analyzed in connection with the cross-channel fraud metric to determine an account cross-channel fraud score associated with the customer.

### BACKGROUND

Online banking provides customers the ability to interact with their bank on their own schedule by providing convenient access to a range of banking services. However, the ability to access a customer's accounts from any place an Internet connection is available may make online banking a frequent and potentially lucrative target for hackers, fraudsters, and/or other malicious entities.

A critical situation may arise, for example, when a bank believes a customer's online banking login credentials may have been compromised. This situation, referred to as “automated validation,” leverages external data, available primarily via third party data breaches (e.g., the Target data breach, etc.), to discover valid login credentials on other sites, such as the bank's site, via automated scripting. Valid credentials are sorted, grouped, and subsequently sold by data brokers to fraudsters who eventually attempt to defraud customers or cause other problems based on the data collected.

Fraudulent actions may include actions for an account takeover, falsifying information related to account ownership, and/or misrepresenting information related to account ownership. Fraudulent actions may also include misrepresentation of assets, misrepresentation of a relationship, misrepresentation of use of an account, and/or misrepresentation of a legitimate use or need for information or actions requested. Additionally, fraudulent actions may include identity theft, identity fraud, fraudulent application for a financial instrument (e.g., credit card), and so on.

Cross-channel fraud (XCF) is a type of victim fraud attack that leverages more than one of an entity's available customer service channels and a victim's account relationships. As used herein an “entity” refers to a financial institution, such as a bank, and a victim refers to a customer of the financial institution. Many entities are able to deal with single channel fraud more effectively than cross-channel fraud. In some instances, cross-channel fraud may be difficult to detect and prevent because many entities deal with fraud in individual channels (e.g., a single product line) on an individual basis. For example, fraud detected in a service channel associated with a credit card for a customer might not be communicated to another service channel associated with a checking account associated with the same customer. Further, cross-channel fraud may not rise to a level in any individual channel (e.g., debit card, checking, credit card, etc.) to be detected solely on that basis. Additionally, newer products and services, and expanded capabilities of online banking, may increase the potential for cross-channel fraud, by allowing for a broader range of interactions on a remote basis. Moreover, in addition to the financial losses suffered by an entity due to cross-channel fraud, there may be a negative impact to customer experience and satisfaction due to an entity's prevention measures and/or an entity's response to a potential (or actual) fraud situation.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system that may facilitate detection of cross-channel fraud (XCF). One such system may include a fraud pattern analysis component that analyzes one or more fraud accounts to identify one or more common patterns of events associated with fraud. Each of the one or more fraud accounts may have been previously subjected to fraud. The system may also include an observation component that monitors a plurality of events associated with a customer (e.g., across product lines for a specific customer, across service channels associated with a customer). The fraud pattern analysis component may determine a first account fraud probability associated with the customer based at least in part on a comparison between the plurality of events and the one or more common patterns of events.

In further aspects, the subject innovation may comprise methods that may facilitate detection of cross-channel fraud. One such method may include identifying, by a system comprising a processor, one or more fraud accounts, wherein each of the one or more fraud accounts has previously been subject to fraud. The method may also include analyzing, by the system, the one or more fraud accounts to determine one or more events associated with an increased probability of fraud. Further, the method may include determining, by the system, a cross-channel fraud metric based on the determined one or more events and analyzing one or more events associated with a customer (e.g., across product lines associated with a customer). In addition, the method may include calculating, by the system, a customer cross-channel fraud score based on the cross-channel fraud metric and the analyzed one or more events.

In another aspect, the subject innovation may include a system that may include a fraud pattern analysis component that identifies a pattern of events associated with fraud based on a comparison between a set of events associated with a fraud account and another set of events associated with a non-fraud account. The system may also include an observation component that monitors a plurality of events occurring across channels associated with a customer. Also included in the system may be a cross-channel fraud metric component that determines in real-time, or near real-time, a cross-channel fraud score for the plurality of events. The system may also include a fraud pattern analysis component that determines a fraud probability for the customer based in part of the cross-channel fraud score. Further, the system may include a fraud mitigation component that implements a fraud mitigation action based on the fraud probability. In some implementations, the system may include a communication component that conveys to an entity the fraud probability and the fraud mitigation action, wherein the entity has a fiduciary relationship with the customer.

To the accomplishment of the foregoing and related ends, certain illustrative aspects of the innovation are described herein in connection with the following description and the annexed drawings. These aspects are indicative, however, of but a few of the various ways in which the principles of the innovation may be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

Aspects of the disclosure are understood from the following detailed description when read with the accompanying drawings.

FIG. 1 illustrates an example, non-limiting system that facilitates detection of, and response to, cross-channel fraud, according to an aspect.

FIG. 2 illustrates an example, non-limiting system for cross-channel fraud detection, according to an aspect.

FIG. 3 illustrates an example, non-limiting method for cross-channel fraud detection, according to an aspect.

FIG. 4 illustrates an example, non-limiting method for facilitating detection of, and response to, cross-channel fraud, according to an aspect.

FIG. 5 illustrates a graph of three example, non-limiting cross-channel fraud score trendlines associated with fraud, which occurred at the end of each of the trendlines.

FIG. 6 illustrates the three trendlines of FIG. 5, showing both model-based techniques and big data techniques of cross-channel fraud detection.

FIG. 7 illustrates a computer-readable medium or computer-readable device comprising processor-executable instructions configured to embody one or more of the provisions set forth herein, according to some embodiments.

FIG. 8 illustrates a computing environment where one or more of the provisions set forth herein may be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation may be practiced without these specific details. In other instances, well-known structures and devices are shown in block diagram form in order to facilitate describing the innovation.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

Furthermore, the claimed subject matter may be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

As used herein, the term to “infer” or “inference” refer generally to the process of reasoning about or inferring states of the system, environment, and/or user from a set of observations as captured via events and/or data. Inference may be employed to identify a specific context or action, or may generate a probability distribution over states, for example. The inference may be probabilistic—that is, the computation of a probability distribution over states of interest based on a consideration of data and events. Inference may also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Some techniques of fraud detection and prevention may be ineffective against cross-channel fraud (XCF) attacks that leverage multiple channels to facilitate fraud. Such inefficiencies may be due to the fact that fraud products may be efficient with respect to fraud based tendencies that are product specific (e.g., debit card, wire transfer, and so on), but may not be efficient across product lines and/or channels. As used herein, a channel refers to a service channel and may include one or more product lines and/or product offerings (e.g., a credit card account, a mortgage loan, a savings account, and so on). In various aspects, the subject innovation may comprise systems and methods that may facilitate detection of, and a response to, cross-channel fraud. In various embodiments, the subject innovation may leverage model-based techniques in combination with big data analytical techniques to identify and respond to cross-channel fraud.

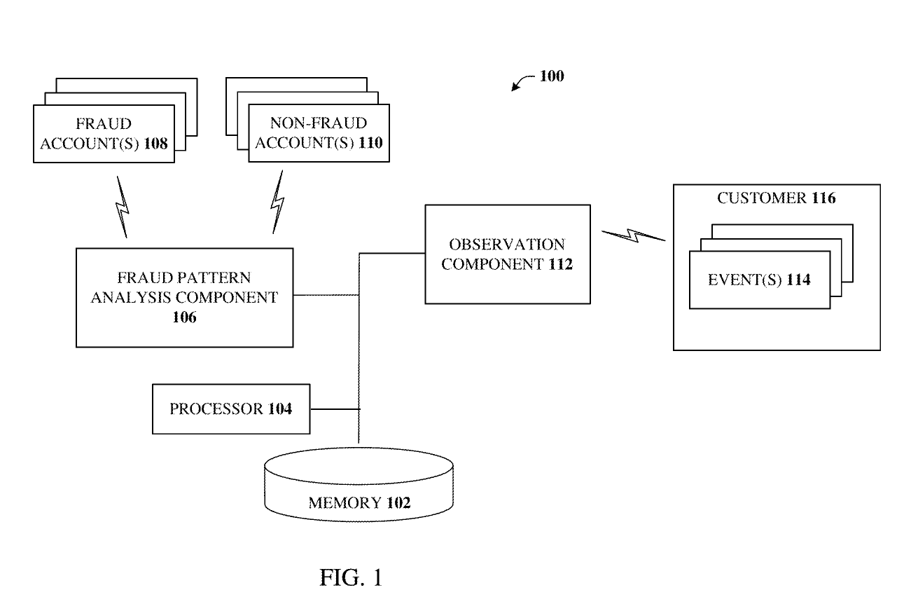

Referring to the drawings, FIG. 1 illustrates an example, non-limiting system 100 that facilitates detection of, and response to, cross-channel fraud, according to an aspect. As discussed, the detection of (and response to) cross-channel fraud may be in connection with a customer, or data indicative of a customer. Thus, the various aspects disclosed herein may be configured to analyze a customer as a whole and not simply as a series of products. For example, various aspects may determine what events are occurring in the customer's world. Such events may include, but are not limited to, how money is being moved, where the money is being moved to/coming from, and other events that are occurring at a customer level and that might denote risk and indicate fraud is being staged.

The system 100 may include at least one memory 102 that may store computer executable components and/or computer executable instructions. The system 100 may also include at least one processor 104, communicatively coupled to the at least one memory 102. The at least one processor 104 may facilitate execution of the computer executable components and/or the computer executable instructions stored in the memory 102. The term “coupled” or variants thereof may include various communications including, but not limited to, direct communications, indirect communications, wired communications, and/or wireless communications.

It is noted that although the one or more computer executable components and/or computer executable instructions may be illustrated and described herein as components and/or instructions separate from the memory 102 (e.g., operatively connected to the memory 102), the various aspects are not limited to this implementation. Instead, in accordance with various implementations, the one or more computer executable components and/or the one or more computer executable instructions may be stored in (or integrated within) the memory 102. Further, while various components and/or instructions have been illustrated as separate components and/or as separate instructions, in some implementations, multiple components and/or multiple instructions may be implemented as a single component or as a single instruction. Further, a single component and/or a single instruction may be implemented as multiple components and/or as multiple instructions without departing from the example embodiments.

The system 100 may also include a fraud pattern analysis component 106 that may be configured to analyze one or more fraud accounts 108. According to an implementation, the one or more fraud accounts 108 analyzed by the fraud pattern analysis component 106 may be accounts determined to have previously been associated with fraud. Each fraud account of the one or more fraud accounts 108 may be associated with different customers. However, according to some implementations, a subset of the one or more fraud accounts 108 may be associated with one customer.

The analysis by the fraud pattern analysis component 106 may include a comparison of the one or more fraud accounts 108 with one or more non-fraud accounts 110. The one or more non-fraud accounts 110 are accounts determined to have not previously been associated with fraud.

The analysis against the one or more non-fraud accounts 110 may be performed to identify one or more common patterns of events that may be associated with fraud. According to an implementation, the one or more common patterns of events may include identification of events that may be associated with fraud. These events may include, for example, adding users to accounts, changing addresses associated with accounts, and so on. Additionally or alternatively, the events may include a determination of an ordering or sequencing of events determined to be associated with fraud. For example, an order or sequence of events may include a determination whether fraud is more likely when event A occurs before event B, when event B occurs before event A, or when the events occur at substantially the same time.

Additionally, the system 100 may include an observation component 112 that may be configured to monitor one or more events 114 associated with a customer 116 (or data indicative of the customer 116). As used herein, a “customer” may refer to one or more humans and/or one or more entities. For example, a customer may be a person, two or more people (e.g., joint banking account, joint loan account, joint mortgage account, and so on), a corporation, a partnership, a sole proprietorship, and so forth. Further, each customer may be associated with one or more channels, which may be associated with banking accounts, loan accounts, or other products (e.g., insurance, investment accounts, brokerage accounts, wealth management accounts, prepaid cards, retirement accounts, credit monitoring, and so on). For example, a first customer might have two checking accounts, one savings account, three credit cards, and a mortgage account. Further to this example, a second customer might have a single checking account, and a third customer might have a savings account, a checking account, and an automobile loan. Thus, in each case, a customer is identified regardless of the number of channels and/or types of channels associated with that customer. Further, the customer is associated with the range of channels and/or products to which the customer is connected, or with which the customer has a relationship.

The customer 116 may be identified based on data indicative of the customer, which may include various types of information that may be used to identify the customer. For example, the data indicative of the customer may include product information, such as a banking account number, a loan account number, a credit card number, or other manners of identifying a particular product associated with one or more service channels of operation. In another example, the data indicative of a customer may include login information, such as a unique user identification/password pair. In another example, the data indicative of the customer may include a mobile identity, an IP address, a mobile subscription identification number (MSIN), an international mobile subscriber identify (IMSI), a telephone number, an email alias, a social media alias, biometric data, and so on.

In various embodiments, the one or more events 114 associated with the customer 116 may include any event associated with the customer 116 (e.g., with products or product lines associated with the customer 116). According to some implementations, the one or more events 114 may include events that are associated with an identified subset of events (e.g., only customers located in a particular state, only customers with activity at a certain branch of a financial institution, only customers with an amount of assets below (or more than) a specified monetary value, and so on). Thus, the observation component 112 may be configured to review the one or more events 114 associated with the customer 116 as a whole, not just as a series of products or as individual products.

Based at least in part on the one or more events 114 monitored by the observation component 112, the fraud pattern analysis component 106 may compare patterns associated with the monitored events 114 with the one or more common patterns of events associated with fraud to determine a probability of fraud.

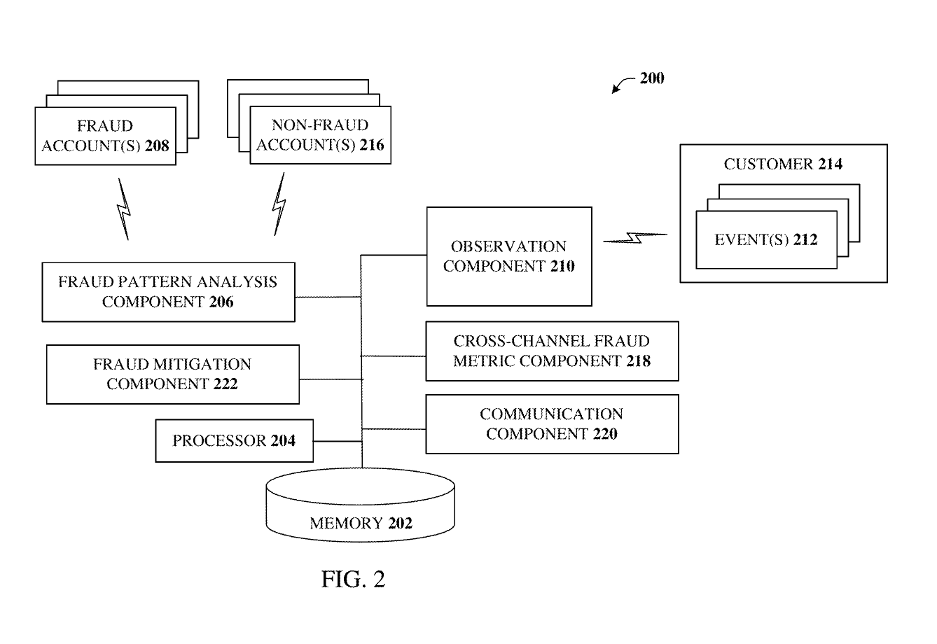

FIG. 2 illustrates an example, non-limiting system 200 for cross-channel fraud detection, according to an aspect. The system 200 may include at least one memory 202 that may store computer executable components and/or computer executable instructions. The system 200 may also include at least one processor 204, communicatively coupled to the at least one memory 202. The at least one processor 204 may facilitate execution of the computer executable components and/or the computer executable instructions stored in the memory 202.

Also included in the system 200 may be a fraud pattern analysis component 206 configured to analyze one or more fraud accounts 208 to identify one or more common patterns of events associated with fraud. Each of the one or more fraud accounts 208 may have been previously subject to fraud.

An observation component 210 may be configured to monitor one or more events 212 associate with a customer 214 (or respective events associated with more than one customer). Further, the fraud pattern analysis component 106 may be further configured to determine a first account fraud probability associated with the customer 214 based, at least in part, on a comparison between the one or more events 212 and the one or more common patterns of events.

The system 200 may also include a cross-channel fraud metric component 218 that may be configured to analyze the one or more fraud accounts 208 and determine events that are associated with increased risk of fraud. According to an implementation, the cross-channel fraud metric component 218 may determine in real-time (or near real-time) a cross-channel fraud score for the plurality of events associated with the customer. For example, the real-time (or near real-time) refers to the analysis being perform at the same time (or substantially the same time) as it is determined that an event has occurred. This determination may be made when a notification is received about the event (e.g., a dynamic notification is transmitted to the cross-channel fraud metric component 218 through various communication means).

The one or more fraud accounts 208 may be analyzed in connection with (or in comparison to) one or more non-fraud accounts 216. According to an implementation, the cross-channel fraud metric component 218 may utilize logistic regression (or another type of probabilistic statistical classification model) to determine the events associated with an increased risk of fraud.

Based on the determined events associated with the fraud accounts 208, the cross-channel fraud metric component 218 may be configured to determine a cross-channel fraud metric used to measure a likelihood of fraud. The cross-channel fraud metric may be based at least in part on events associated with fraud, which may be determined by classification such as logistic regression, or another classification model.

In some embodiments, the cross-channel fraud metric component 218 may be configured to identify a subset of interactions and/or events associated with a probability of fraud that meets or exceeds a threshold fraud level. For example, the threshold fraud level may be a configurable fraud value. If analysis indicates a level at or exceeding the threshold fraud level, there may be an increased probability of fraud. For example, a threshold fraud level may be determined based on a probability that one or more events (taken alone, in sequence or in combination with other events, and so forth) is an indication that fraud is more likely than not to occur. Additionally, the cross-channel fraud metric component 218 may be configured to identify one or more trend lines of cross-channel fraud metric scores that are associated with fraud based on analysis of the one or more fraud accounts.

Additionally or alternatively, based on the monitored events, the cross-channel fraud metric component 218 may determine a customer cross-channel fraud score associated with the customer 214. The cross-channel fraud score may be for all products/product lines (e.g., channels) associated with the customer 214, a subset of the products/product lines (e.g., channels), and/or a single product/product line (e.g., channel). Further, the cross-channel fraud metric component 218 may determine historical trends in the customer cross-channel fraud score. Based on one or more of the current (e.g., the customer channel(s) under analysis) account cross-channel fraud score or trends in the customer cross-channel fraud score, a probability of fraud may be determined. Accordingly, preventative measures may be taken in order to mitigate the occurrence of fraud.

In various embodiments, the system 200 may include a communication component 220 that may be configured to provide one or more entities with information. Such information may include data indicative of the cross-channel fraud score, trends in the cross-channel fraud score, comparisons between patterns of events associated with the customer 214 and/or common patterns of events associated with fraud, a probability or likelihood of fraud, etc. The notified entities may include individual lines of business associated with the customer 214 and/or each customer product line (e.g., checking, debit card, credit card, home equity line of credit, wire transfer, and so on), fraud prevention entities, etc. In some instances the entity may be a financial institution and/or persons associated with the financial institution. Additionally or alternatively, the entity may be a third party monitoring source or another type of entity that has a trusted relationship with the financial institution.

In various aspects, the one or more entities receiving information from the communication component 220 may receive information filtered by the communication component 220. The information may be filtered based on entity-selected feedback, such as location, account types, account quantities, etc. For example, if an entity only wants to evaluate accounts with $1,000 or more, or accounts in (or not in) Florida, etc., that selectively filtered information is provided to the entity. Such entity-selected settings may be configurable such that, depending on the areas of concern, the data may be automatically filtered and sorted for focused monitoring by the entity.

In some embodiments, the system 200 may comprise a fraud mitigation component 222 that may be configured to implement one or more fraud mitigation actions (e.g., customer notification, account lockout, etc.), which may be based on any of a variety of conditions. These conditions may include, for example, the cross-channel fraud score being above a threshold value and/or the at least one trend corresponding to at least one of the trend lines of cross-channel fraud metric scores that are associated with fraud. The conditions may also include, for example, one of the patterns of events corresponding to at least one of the one or more common patterns of action with at least a threshold probability, and so on. The fraud mitigation action is intended to protect both the customer and the entity (e.g., financial institution) with which the customer has a relationship.

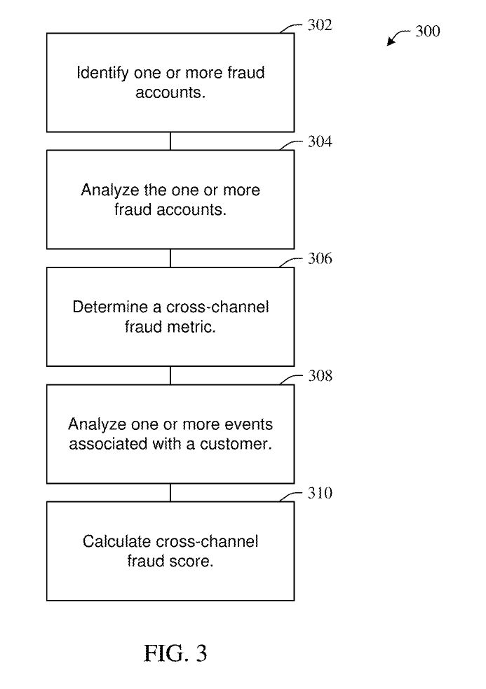

FIG. 3 illustrates an example, non-limiting method 300 for cross-channel fraud detection, according to an aspect. The method 300 in FIG. 3 may be implemented using, for example, any of the systems, such as a system 100 (of FIG. 1), described herein. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Method 300 starts, at 302, with identifying one or more fraud accounts. Each of the one or more fraud accounts may be determined to have previously been subject to fraud. At 304, the one or more fraud accounts are analyzed to determine or more events associated with an increased probability of fraud. For example, it might be determined that, based on a comparison among at least a subset of fraud accounts, particular events, or patterns of events, occurs prior to a fraud event (e.g., a financial loss, data breach, and so on).

At 306, a cross-channel fraud metric is determined. For example, the cross-channel fraud metric may be determined based on the one or more events determined at 304.

At 308, one or more events associated with a customer are analyzed. For example, events may include both monetary transactions (e.g., transfer of money, withdrawal of money, purchase of stocks, viewing of balances, and so on) and non-monetary transactions (e.g., addition of a joint owner on an account, address change, and so on).

A customer cross-channel fraud score is calculated at 310. The customer cross-channel fraud score may be calculated based on the cross-channel fraud metric and the analyzed one or more events. The customer cross-channel fraud score may be calculated across all channels and/or products associated with the customer, not necessarily to a single account.

Based on the cross-channel fraud score, a determination may be that there is no indication that a fraud is likely to occur and, therefore, no further action is taken. Alternatively, a determination may be that it is likely that fraud will occur based on the cross-channel fraud score. In this case, depending on the confidence of the likelihood of the expected fraud occurring, appropriate actions may be taking (e.g., notifying the client to change a password, changing a customer account number, and so on). The confidence may be proportional (or disproportional) to the cross-channel fraud score, according to various implementations.

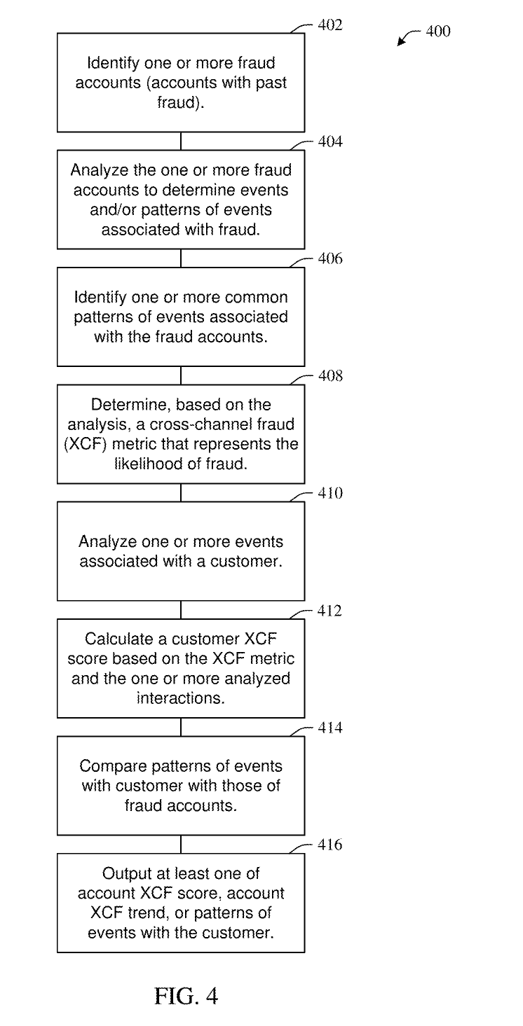

FIG. 4 illustrates an example, non-limiting method 400 for facilitating detection of, and response to, cross-channel fraud, according to an aspect. The method 400 in FIG. 4 may be implemented using, for example, any of the systems, such as a system 200 (of FIG. 2), described herein. The method 400 may begin at 402 by identifying one or more fraud accounts, that is, accounts on which fraud has previously occurred. Next, at 404, the method 400 may continue by analyzing the one or more fraud accounts. For example, the one or more fraud accounts may be analyzed in connection with one or more non-fraud accounts (accounts with no past fraud), to determine at least one of events associated with the fraud accounts or patterns of events (which may, but need not, include sequencing or order information, such as which events occur before or after which other events) associated with the fraud accounts. For example, classification techniques such as logistic regression may be employed to identify events (e.g., any of a thousand or more ways in which a customer might interact with an account or with a bank in connection with the account, etc.) associated with an increased probability of fraud.

At 406, the method 400 may continue by identifying one or more common patterns of actions associated with the one or more fraud accounts. Additionally, the method 400 may include, at 408, determining a cross-channel fraud (XCF) metric that represents a likelihood of fraud. The cross-channel fraud metric may be computed based on events identified at 404 as associated with an increased probability of fraud. For example, the cross-channel fraud metric may be computed based on an identified subset of all event types, wherein the identified subset comprises event types more closely associated with an increased probability of fraud. Additionally, the one or more fraud accounts may be analyzed to determine trend lines of cross-channel fraud metric scores that are associated with fraud.

At 410, one or more events associated with a customer may be analyzed. The events analyzed in connection with the customer may include different products and/or product lines (e.g., credit card, certificate of deposit account, home equity line of credit, and so on). Based on the event analysis, a customer cross-channel fraud score may be calculated at 412. The cross-channel fraud score may be based on the one or more analyzed events and the cross-channel fraud metric. Additionally, as historical values of the customer cross-channel fraud score are obtained, at least one trend in the customer cross-channel fraud score may be determined. Additionally, at 414, patterns of events associated with the customer (e.g., across product lines, or across different accounts) may be compared to the one or more common patterns of actions associated with the one or more fraud accounts.

At 416, the method 400 may provide at least one of the cross-channel fraud score, the cross-channel fraud score trends, and the compared patterns of events to a fraud prevention entity (e.g., individual lines of business, a third party, etc.). Additionally or alternatively, one or more fraud mitigation actions may be implemented (e.g., customer notification, account lockout, and so on), which may be based on any of a variety of conditions. These conditions may include, for example, the cross-channel fraud score being above a threshold value, the at least one trend corresponding to at least one of the trend lines of cross-channel fraud metric scores that are associated with fraud, one of the patterns of events corresponding to at least one of the one or more common patterns of action with at least a threshold probability.

In various embodiments, the subject innovation may analyze one or more fraud accounts (accounts that have had instances of fraud) in comparison with non-fraud accounts to determine events (e.g., events associated with the fraud accounts) and patterns of events (e.g., unordered collections of events, ordered collections of events, etc.) that are associated with fraud. Additionally, this analysis may be used to determine a cross-channel fraud metric, which may be a formula based on a plurality of events determined to be significant relevant to a probability of fraud. The cross-channel fraud metric may represent a likelihood of fraud associated with an account via a cross-channel fraud score generated by applying the cross-channel fraud metric to the account. Moreover, the cross-channel fraud metric may be applied to the fraud and non-fraud accounts to determine cross-channel fraud trendlines that are associated with increased likelihood of fraud.

For example, in experiments conducted, increased likelihood of fraud has been associated with different trendlines. One trendline may be where the cross-channel fraud score increases linearly for a period of time. Another trendline may be where the cross-channel fraud score elevates and remains elevated for a period of time. Yet another may be a trendline where the cross-channel fraud score remains low for a period of time and then elevates rapidly. However, it is noted that other trendlines may indicate cross-channel fraud and these specific trendlines are provided for purposes of explaining the various aspects disclosed herein

By analyzing additional fraud and non-fraud accounts to determine events and patterns of events that distinguish the accounts, more details and more accurate information (e.g., in terms of events, patterns, cross-channel fraud metric, etc.) may be obtained. In various embodiments, the combined number of fraud and non-fraud accounts may include the total number of customer accounts with a bank, for example, which may number in the millions.

Experimental results discussed herein employed the Teradata Aster Discovery Platform for big data analytics. Additionally, each of these analytical steps may be repeated (e.g., periodically, or as new frauds occur, etc.) to update identified events relevant to a probability of fraud, identified common patterns of events associated with fraud, a formula used to determine a cross-channel fraud metric, patterns of cross-channel fraud trendlines associated with increased likelihood of fraud, etc.

In various aspects, the subject innovation may employ both model-based approaches and big data analytical approaches to fraud detection. In accordance with a model-based approach, fraud may occur in recognizable stages, which may include: (1) normal activity; (2) first risky event; (3) staging; and (4) money out (e.g., fraud). Identification of fraud before the final stage, where the actual financial harm occurs, may be critical to minimizing losses. In various aspects, the subject innovation may employ a cross-channel fraud metric and associated cross-channel fraud scoring of accounts to identify fraud earlier, such as after the first risky event or during staging.

As discussed herein, the cross-channel fraud metric may be based on events that have been identified as being associated with an increased likelihood of fraud. Such events may include, but are not limited to, events such as adding users to the account, recent account opens, account mix profiles and balances, card activity, card transaction declines, check orders, online check views, hard holds on demand deposit accounts, Falcon® risk scores, non-monetary profile changes (e.g., address changes, etc.), telephone activity, etc.

In accordance with further aspects, characteristics of cross-channel fraud detection and prevention may lend themselves well to big data analytics. There may be hundreds or more than a thousand potential cross-channel events associated with each account. This represents a high variety of data; with millions of accounts at larger banks, there is a very high volume of data; and with each account having a potentially large number of events in a given day, the data is generated at a high velocity. These characteristics (e.g., volume, variety, and velocity) may make the problem of cross-channel fraud well suited to big data analytics. Given the large number of events that may lead up to fraud, and the relevance in many instances of the order in which these events occur (sequencing), there is a high degree of complexity to algorithms involved in determining which patterns of sequences are associated with elevated fraud probabilities. Due to the complexity and large data sets involved, hypothesis testing for this situation may be suited to big data analytics, which may employ parameterized SQL-like functions that may enable rapid hypothesis testing, such as the following:

```
select * from npath(“Advanced Algorithm”
      on( “The Analytic dataset”)
      partition by “sessionID” order by “Time”
PATTERN (“Which sequences?”)
SYMBOLS (“Define my events” )
RESULT (“The desired output to a table in Aster” )
)-- end npath
where pathlength>2;
```

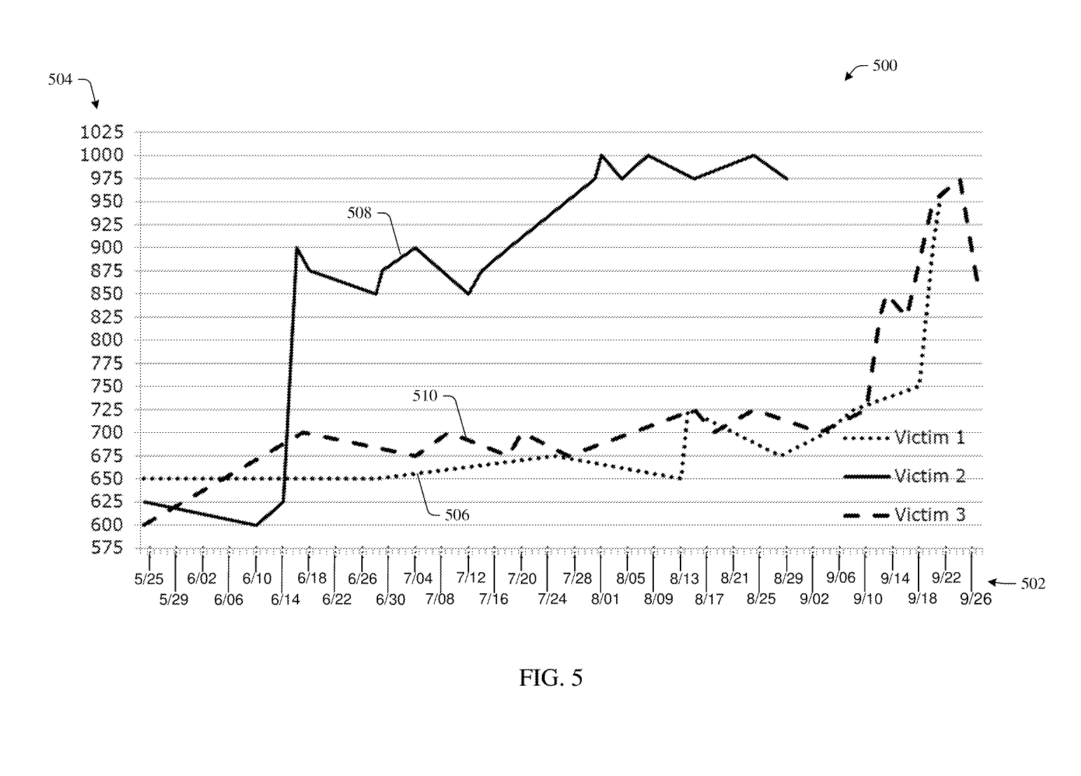

FIG. 5 illustrates a graph 500 of three example cross-channel fraud score trendlines associated with fraud. In the graph, a date of occurrence is indicated along the horizontal axis 502 and the model score is indicated on the vertical axis 504. In each of the illustrated example cases, the fraud occurred at the end of each of the trendlines. Victim 1, indicated by dotted line 506, was associated with a loss of $275,000 removed by cashier's check via store. Victim 2, indicated by solid line 508, was associated with a loss of $89,000 removed by wire via store. Victim 3, indicated by dashed line 510, was associated with a loss of $30,000 removed by in-clearing. In terms of score trendlines, victim 1 showed a pattern with an elevated cross-channel fraud score early and for an extended period of time, whereas victims 2 and 3 showed trendlines with relatively low cross-channel fraud scores for an extended period, followed by a rapid increase prior to money out.

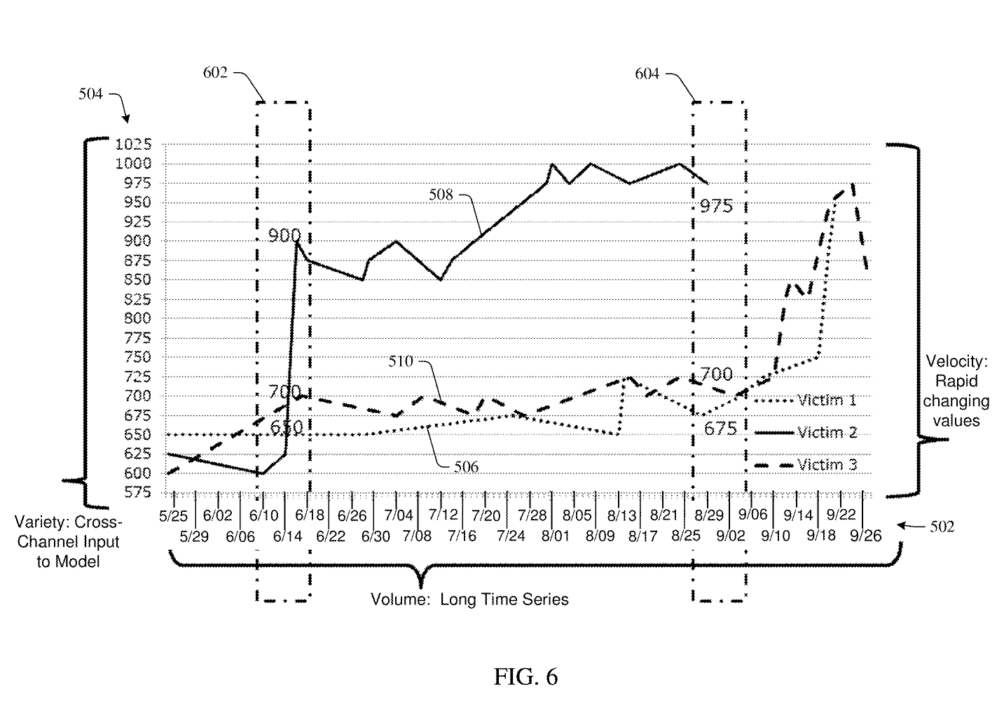

FIG. 6 illustrates the three trendlines of FIG. 5, showing both the model-based techniques (e.g., in the instantaneous score values at various points in time, etc.) and big data techniques (e.g., in patterns of the cross-channel fraud score trendlines, etc.). As illustrated, variety relates to the cross-channel input to the model. Volume represents a long time series (e.g., over a period of days, weeks, months, and so on). Further, velocity relates to rapidly changing events. As represented by the first dashed block 602, the scores are represented as model score 650 for the first customer 506, model score 900 for the second customer, and model score 700 for the third customer 510. At another snapshot in time, represented by the second dashed block 602, the scores are represented as model score 675 for the first customer 506, model score 975 for the second customer, and model score 700 for the third customer 510.

In various aspects, the subject innovation may leverage big data analytic tools on an ongoing basis to continue to update common patterns associated with fraud, cross-channel fraud metric, and cross-channel fraud trendlines associated with fraud. In further aspects, the subject innovation may incorporate false positive ratio measures for fraud identification, such as by tying identification of fraud in connection with an account to quantifiable losses, by weighting fraud identifications based on amount lost, etc. In some aspects, the subject innovation may include segmentation analysis by online banking status, loss type, or type of fraud, for example, DDA victim fraud, credit card fraud, debit card fraud, etc.

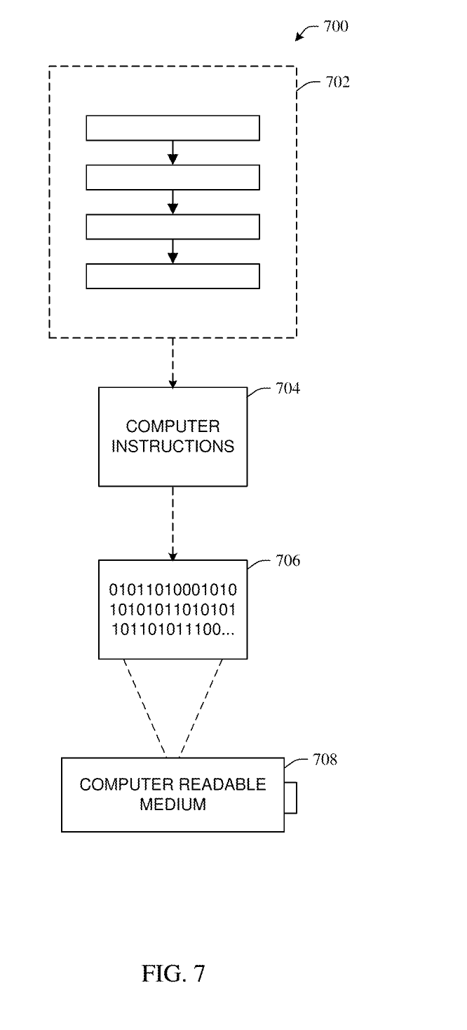

Still another embodiment may involve a computer-readable medium comprising processor-executable instructions configured to implement one or more embodiments of the techniques presented herein. An embodiment of a computer-readable medium or a computer-readable device that is devised in these ways is illustrated in FIG. 7, wherein an implementation 700 comprises a computer-readable medium 708, such as a CD-R, DVD-R, flash drive, a platter of a hard disk drive, etc., on which is encoded computer-readable data 706. This computer-readable data 706, such as binary data comprising a plurality of zero's and one's as shown in 706, in turn comprises a set of computer instructions 704 configured to operate according to one or more of the principles set forth herein. In one such embodiment 700, the processor-executable computer instructions 704 is configured to perform a method 702, such as at least a portion of one or more of the methods described in connection with embodiments disclosed herein. In another embodiment, the processor-executable instructions 704 are configured to implement a system, such as at least a portion of one or more of the systems described in connection with embodiments disclosed herein. Many such computer-readable media may be devised by those of ordinary skill in the art that are configured to operate in accordance with the techniques presented herein.

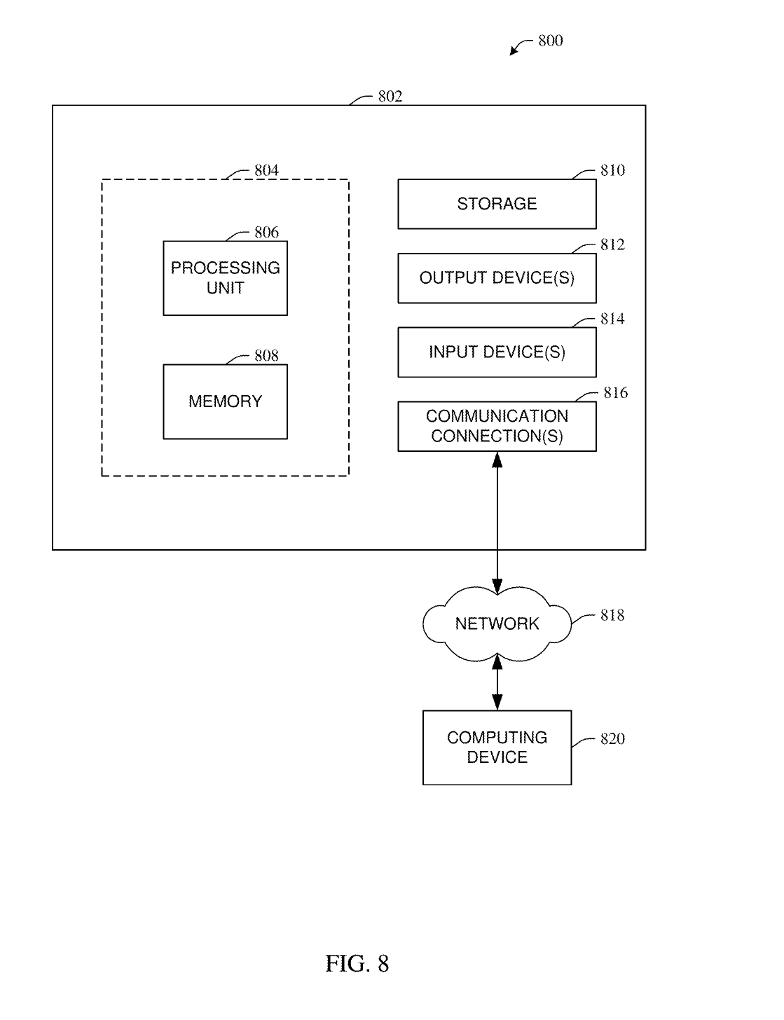

FIG. 8 and the following discussion provide a description of a suitable computing environment in which embodiments of one or more of the provisions set forth herein may be implemented. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates a system 800 comprising a computing device 802 configured to implement one or more embodiments provided herein. In one configuration, computing device 802 may include at least one processing unit 806 and memory 808. Depending on the exact configuration and type of computing device, memory 808 may be volatile, such as RAM, non-volatile, such as ROM, flash memory, etc., or some combination of the two. This configuration is illustrated in FIG. 8 by dashed line 804.

In these or other embodiments, device 802 may include additional features or functionality. For example, device 802 may also include additional storage such as removable storage or non-removable storage, including, but not limited to, magnetic storage, optical storage, and the like. Such additional storage is illustrated in FIG. 8 by storage 810. In some embodiments, computer readable instructions to implement one or more embodiments provided herein are in storage 810. Storage 810 may also store other computer readable instructions to implement an operating system, an application program, and the like. Computer readable instructions may be loaded in memory 808 for execution by processing unit 806, for example.

The term “computer readable media” as used herein includes computer storage media. Computer storage media includes volatile and nonvolatile, removable and non-removable media implemented in any method or technology for storage of information such as computer readable instructions or other data. Memory 808 and storage 810 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by device 802. Any such computer storage media may be part of device 802.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 802 may include one or more input devices 814 such as keyboard, mouse, pen, voice input device, touch input device, infrared cameras, video input devices, or any other input device. One or more output devices 812 such as one or more displays, speakers, printers, or any other output device may also be included in device 802. The one or more input devices 814 and/or one or more output devices 812 may be connected to device 802 via a wired connection, wireless connection, or any combination thereof. In some embodiments, one or more input devices or output devices from another computing device may be used as input device(s) 814 or output device(s) 812 for computing device 802. Device 802 may also include one or more communication connections 816 that may facilitate communications with one or more other devices 820 by means of a communications network 818, which may be wired, wireless, or any combination thereof, and may include ad hoc networks, intranets, the Internet, or substantially any other communications network that may allow device 802 to communicate with at least one other computing device 820.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a fraud pattern analysis component that analyzes one or more fraud accounts to identify one or more common patterns of events associated with fraud, wherein each of the one or more fraud accounts has previously been subject to fraud; and
an observation component that monitors a plurality of events associated with a customer,
wherein the fraud pattern analysis component determines a first account fraud probability associated with the customer based at least in part on a comparison between the plurality of events and the one or more common patterns of events.

2. The system of claim 1, further comprising a cross-channel fraud metric component that analyzes the one or more fraud accounts and determines a cross-channel fraud metric that measures a likelihood of fraud, wherein the cross-channel fraud metric component analyzes the plurality of events in connection with the cross-channel fraud metric to determine a customer cross-channel fraud score associated with the customer.

3. The system of claim 2, further comprising a communication component that transmits at least one of the cross-channel fraud score or the first account fraud probability to an entity associated with the customer.

4. The system of claim 3, wherein the communication component transmits the at least one of the cross-channel fraud score or the first account fraud probability based at least in part on one or more entity-selected settings.

5. The system of claim 3, wherein the communication component transmits the at least one of the cross-channel fraud score or the first account fraud probability based at least in part on one or more of the first account fraud probability exceeding a first threshold or the customer cross-channel fraud score exceeding a second threshold.

6. The system of claim 2, wherein the cross-channel fraud metric component determines one or more fraud cross-channel fraud score trendlines associated with the one or more fraud accounts, wherein the cross-channel fraud metric component determines a customer cross-channel fraud score trendline associated with the customer account, and wherein the cross-channel fraud metric component determines a second account fraud probability based on a comparison between the customer cross-channel fraud score trendline and the one or more fraud cross-channel fraud score trendlines.

7. The system of claim 2, wherein the cross-channel fraud metric component employs logistic regression to identify one or more event types associated with fraud, and wherein the cross-channel fraud metric is based at least in part on the identified one or more event types.

8. The system of claim 7, wherein each event of the plurality of events is associated with an event type of the identified one or more event types.

9. The system of claim 1, wherein each of the one or more common patterns of events comprises an ordering of the common pattern of events, and wherein the comparison between the plurality of events and the one or more common patterns of events comprises a comparison between the orderings of the one or more common patterns of events and an account ordering of the plurality of events.

10. The system of claim 1, further comprising a fraud mitigation component that at least one of locks out the customer account or notifies a customer associated with the customer account when one or more of the first account fraud probability exceeds a first threshold or the second account fraud probability exceeds a second threshold.

11. A method, comprising:
identifying, by a system comprising a processor, one or more fraud accounts, wherein each of the one or more fraud accounts has previously been subject to fraud;
analyzing, by the system, the one or more fraud accounts to determine one or more events associated with an increased probability of fraud;
determining, by the system, a cross-channel fraud metric based on the determined one or more events;
analyzing, by the system, one or more events associated with a customer; and
calculating, by the system, a customer cross-channel fraud score based on the cross-channel fraud metric and the analyzed one or more events.

12. The method of claim 11, further comprising:
identifying, by the system, one or more common patterns of events associated with the one or more fraud accounts; and
comparing, by the system, a pattern of events to the identified one or more common patterns of events to determine a first account fraud probability.

13. The method of claim 12, further comprising transmitting, by the system, at least one of the cross-channel fraud score or the first account fraud probability to an entity associated with the customer.

14. The method of claim 13, wherein the at least one of the cross-channel fraud score or the first account fraud probability are transmitted based at least in part on one or more entity-selected settings.

15. The method of claim 13, wherein the at least one of the cross-channel fraud score or the first account fraud probability are transmitted based at least in part on one or more of the first account fraud probability exceeding a first threshold or the customer cross-channel fraud score exceeding a second threshold.

16. The method of claim 11, further comprising
determining, by the system, one or more fraud cross-channel fraud score trendlines associated with the one or more fraud accounts
determining, by the system, a customer cross-channel fraud score trendline associated with the customer; an
determining, by the system, a second account fraud probability based on a comparison between the customer cross-channel fraud score trendline and the one or more fraud cross-channel fraud score trendlines.

17. The method of claim 11, wherein the determining the cross-channel fraud metric comprises employing logistic regression to identify one or more event types associated with fraud, wherein the cross-channel fraud metric is based at least in part on the identified one or more event types.

18. The method of claim 17, wherein each event of the plurality of events is associated with an event type of the identified one or more event types.

19. A system, comprising:
a fraud pattern analysis component that identifies a pattern of events associated with fraud based on a comparison between a set of events associated with a fraud account and another set of events associated with a non-fraud account;
an observation component that monitors a plurality of events occurring across channels associated with a customer;
a cross-channel fraud metric component that determines in real-time, or near real-time, a cross-channel fraud score for the plurality of events, wherein the fraud pattern analysis component determines a fraud probability for the customer based in part of the cross-channel fraud score; and
a fraud mitigation component that implements a fraud mitigation action based on the fraud probability.

20. The system of claim 19, further comprising a communication component that conveys to an entity the fraud probability and the fraud mitigation action, wherein the entity has a fiduciary relationship with the customer.
